(19) United States
(12) Patent Application Publication
(10) Pub. No.: US 2018/0225719 A1
(43) Pub. Date: Aug. 9, 2018

(54) System and Methods for Operating an Information Exchange

(71) Applicant: Brian David McFadden, New York, NY (US)

(72) Inventor: Brian David McFadden, New York, NY (US)

(21) Appl. No.: 15/891,363

(22) Filed: Feb. 7, 2018

Related U.S. Application Data
(60) Provisional application No. 62/456,589, filed on Feb. 8, 2017.

(51) Int. Cl. G06Q 30/02

(52) U.S. Cl. CPC G06Q 30/0269; G06Q 50/01; G06Q 30/0242

(57) ABSTRACT

Methods and apparatuses useful for operating, regulating, and controlling an information exchange. For example, in a simplified description of one embodiment, mechanisms and methods are disclosed to dynamically determine from metrics for each information consumer an exchange value for each potential information item. Among other uses, the exchange value allows information items to be ranked and provides a component for dynamically determining, in conjunction with metrics, the bounds on a set of potential information items that may be included in the information stream of the information consumer. Further disclosed mechanisms and methods, for example, support broad dynamic control and automated operations of the information exchange.

### CROSS-REFERENCE TO RELATED APPLICATIONS

This application claims the benefit of provisional patent application No. 62/456,589 filed Feb. 8, 2017 by Brian D McFadden.

### BRIEF DESCRIPTION OF DRAWINGS

FIG. 1. Describes an example of an information exchange

FIG. 2. Describes an example of the producer interactions

FIG. 3. Describes an example of the interactions of a general user

FIG. 4. Describes an example of the interactions of the consumer

FIG. 5. Describes an example priority grid with example include region and threshold boundary

FIG. 6. Describes example connections between components

FIG. 7. Flow chart for an include region generating apparatus

FIG. 8. Flow chart for determining impact from a shift in metrics

### DETAILED DESCRIPTION

### Base System Infrastructure

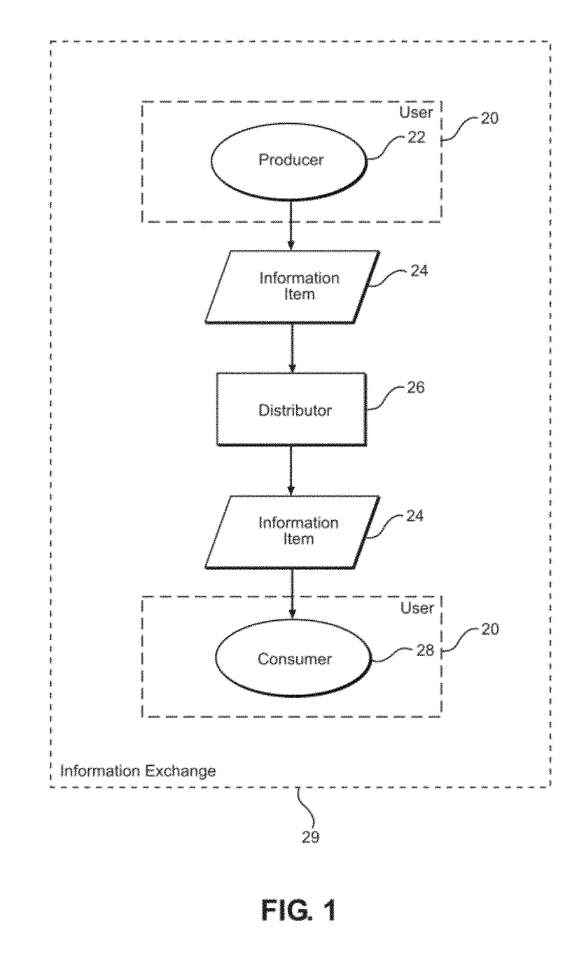

An example of an information exchange 29 is shown in FIG. 1. A user 20 of the information exchange 29 may be either an information producer 22 or an information consumer 28 or both. The information exchange 29 delivers an information item 24 from the information producer 22 to the information consumer 28. In the most general definition an information exchange consists of one or more producers, one or more consumers and a distributor 26. The distributor 26 specifies how the information items flow from producer to consumer.

The distributor 26 can take multiple forms, for example an information switch including simple pass through, publisher to consumer, sender to receiver, publish-subscribe, or any other form where information is transferred from a producer to a consumer. The distributor 26 would include for example cases where the consumer friends or follows one or more producers or joins a group or where a producer and consumer have agreed to follow or friend or exchange information with each other and allow the other party to do the same. The distributor 26 may support subscriptions or not. If subscriptions are supported, the consumer 28 may be subscribed to one, several or all producers. If the distributor 26 does not support subscriptions the consumer 28 will be able to receive from all producers. There may be one or multiple producer 22. There may be one or multiple consumer 28. The information exchange 29 could be a social network, a group within a social network, a list server, a forum, a publishing system, a content management system, a news aggregation service, a news feed, a newsletter, a digest, offers, alerts, an ad exchange, an ad network, email client, news reader, web browser, portal or any service that facilitates a flow of information items from producers to consumers.

The producer 22 is the user 20 who will send, post, place, contribute, publish, author, create, direct, respond, or otherwise cause information to be distributed to, made available by, or made viewable by, one or more other users of the information exchange. FIG. 1 is not intended to show every detail of the information flow.

The information consumer 28 is the user who will receive information items originating from the producers. The consumer 28 may or may not consume the information items made available to them.

Note that the labels producer and consumer are relative to information production and information consumption and in no way imply a commercial relationship.

The information item 24 can be a message, email, notice, response, video clip, audio clip, news, article, story, solicitation, offer, advertisement, URL, or any other form of communication that can be sent or made available by a producer to a consumer.

An information stream is a collection or set of information items delivered sequentially or together to a consumer 28, either directly or embedded, via a medium including, but not limited to, print, email, web feeds, mobile messaging, video, audio, broadcast, or via any other means of delivering information.

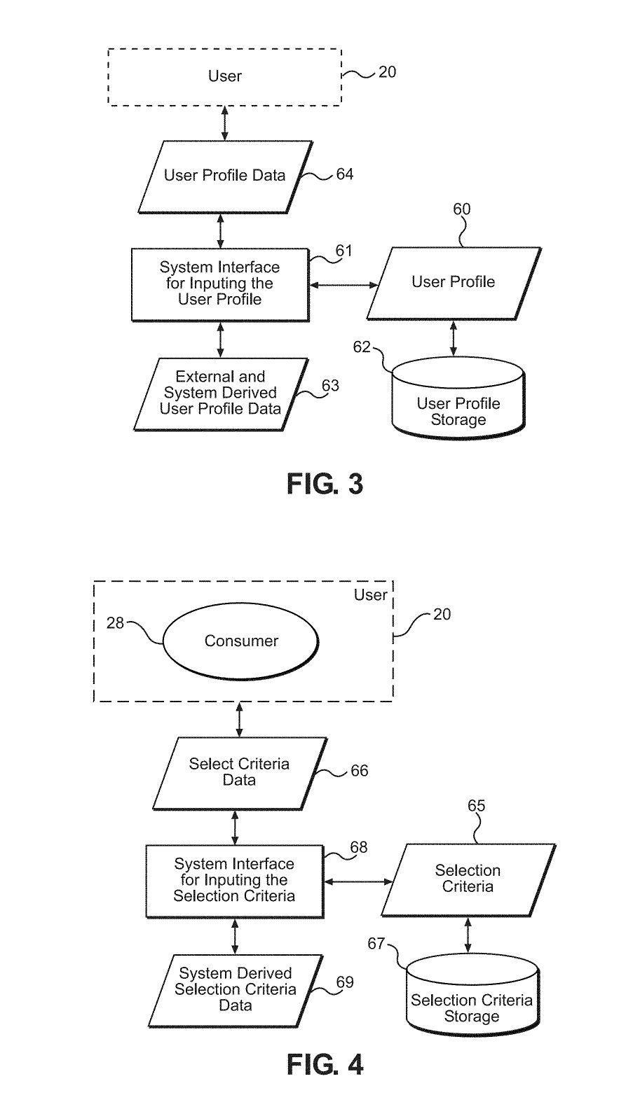

In FIG. 3 shows an example of an information exchange 29 where user 20 may enter user profile data 64 into a system interface for inputting the user profile 61. The system interface for inputting the user profile 61 stores the user profile 60 in a user profile storage 62. The user profile storage may be an internal part of the information exchange, external to the information exchange, or a combination of internal and external. A set of system derived user profile data 63 can also be stored in the user profile storage 62, and in some system, the user may not input any user profile data.

A user profile 60 includes available information, not limited to form, about the user. This includes but is not limited to behavior, biographic, demographic, historical, ratings, feedback, tracking, or other general or specific information from sources internal and external to the information exchange 29. The form for the user profile storage includes relational database, name value pair, no-sql, hierarchical data, objects, nested objects, nested hierarchical data, or combination of databases in a single source or in multiple sources. If accessible via an API the user profile 60 may be represented by XML, JSON, CVS, or any other appropriate data representations.

The consumer 28 in FIG. 4 may enter a selection criteria data 66 into a system interface for inputting the selection criteria 68, and a selection criteria 65 is stored in a selection criteria storage 67. The selection criteria 65 can indicate the type or set of information items that the consumer is potentially interested in or not interested in receiving. The system interface for inputting the selection criteria 68 stores the selection criteria in a selection criteria storage 67. The selection criteria storage 67 can be internal to the information exchange 29, external to the information exchange 29, or a combination of internal and external. Selection criteria can also include a system derived selection criteria 69 that can also be stored in the selection criteria storage 67. In one embodiment, the selection criteria may be stored with the user profile data and the user profile storage and selection criteria storage may be the same.

In one embodiment, the selection criteria storage and user profile storage may be stored together on contiguous storage for fast access and processing.

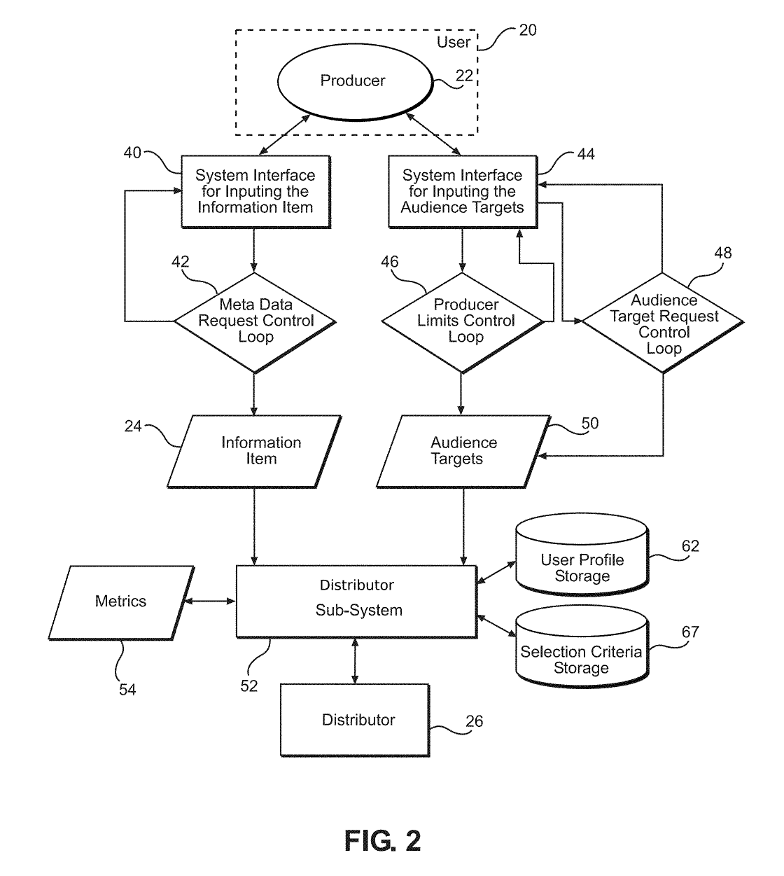

In FIG. 2, for example, audience targets 50 define a set of consumers or audiences that a producer 22 would like to reach or not reach. A system interface for inputting the audience targets 44 interacts with a producer limits control loop 46 and an audience target request control loop 48. The producer limits control loop 46 and the audience target request control loop 48 regulate the audience targets 50 included with an information item 24 to be processed by a distributor sub-system 52.

In FIG. 2, is and example of a system interface for inputting the information item 40 receives an information item 24 from the producer 22. A meta data request control loop 42 may interact with the system interface for inputting the information item 40 and regulates the amount of additional descriptive data that is collected when an information item 24 is entered. In FIG. 2, the distributor sub-system 52 processes the information item 24, audience targets 50, a set of metrics 54, user profiles from the user profile storage 62, and selections criteria from the selection criteria storage to determine what consumers should get, receive, or view the information item as described below. The metrics 54 may be measures, statistics, and parameters obtained, in direct or computed form, from one or more sources internal or external to the information exchange.

In one embodiment, the distributor sub-system 52 and the distributor 26 can be the same. In another embodiment, they may be separate.

### Operational Description

In one embodiment, the system described here is the information exchange or an integral part of the information exchange. In another embodiment, the system will exist separately from the information exchange as a sub-system interacting with the information exchange as detailed below.

In one embodiment the system is computer coded software. In one embodiment, the system operates on a computer network or computer system or specially configured computer system.

In one embodiment the system or information exchange can be any combination of one or more physical computer hardware systems, physical servers, devices, mobile devices, CPUs, auxiliary CPUs, embedded processors, circuits, workstations, desktop computers, virtual devices, virtual servers, virtual machines, or similarly related hardware with an applicable operating system appropriate for the specific hardware and, in the case of more than one, interconnected via a private or public network.

In one embodiment, the system may operate as a self regulated or automatic control system.

### The Producer

In one embodiment, the producer may enter the information item 24 into a system interface for inputting the information item 40. The information item may consist of contents and a meta description. The contents can include summary, title, full story, image, video, audio, rich media, or other primary information delivery objects. The meta description can include abstract, source, keywords, authors, bylines, related links, topics, subjects, types, restrictions, pricing or any other fields or objects or hierarchical data used to classify, categorize, track, identify or otherwise describe the contents and the information item. In one embodiment, the meta data description and the information item may be the same.

In one embodiment, the producer may enter the audience target into the system interface for inputting the audience targets 44. The audience target describes the consumers that the producer would like to reach or not reach. The specification of an audience target can reference any aspect of the user profile to specify the audience. The audience target will have an action to specify if it is desired by the producer for the user matching the audience target to receive the information or not. In one embodiment, the action may indicate indifference to the matching user receiving it. In one embodiment, the default action may be indifference. In one embodiment, the system interface for inputting the information item and the system interface for inputting the audience targets may be the same.

In one embodiment, the producer may specify one or more additional audience targets that they want.

In one embodiment, the producer 22 may construct an audience target and priority by selecting one or more parameters from available data in the user profile of the consumer and assign a priority to values for each discrete parameters and range of values for continuous parameters. The max and min values for all combination of field values may be used to determine a normalized priority scale.

In one embodiment, the producer may have an archive of predefined audience targets that can be selected instead of entering and creating new audience targets.

In one embodiment, the information items and audience targets may be sent to a distributor sub-system.

In one embodiment, the distributor sub-system may be integral with the information exchange distributor. In one embodiment, the distributor sub-system can be external to the information exchange distributor.

In one embodiment, producers may use visual input sliders to indicate audience targets and priorities for specific profile attributes. For example, an audience target with higher priority targets based by years of experience of the consumer. In one embodiment, producers may use drag and drop visuals to rank audience targets and set audience target priorities.

In one embodiment, the producer's entered audience target may be applied to single information item, multiple information items, or all information items from that producer.

In one embodiment, the producer may be an autonomous agent.

### The User

In one embodiment, the user, producer and consumer, may enter data into the user profile 60. In one embodiment, the user profile 60 may also include system data and information about the user including, but not limited to, performance, behavioral, history, tracking, or any other information that the system can record or compute for a user. In one embodiment, the user profile may also include external information obtained from external systems including, but not limited to, performance, behavioral, history, tracking, records, or any other information that can be obtained or computed from external systems or combined with internal profile data. In one embodiment, the user profile may have data from all data sources.

The information exchange user 20 may enter user profile data 64 into a system interface for inputting the user profile 61. The system interface for inputting the user profile 61 stores the user profile data 64 in a user profile storage 62. In one embodiment, the user profile storage may be part of the information exchange 29. In another embodiment, the user profile storage 62 may be external to the information exchange 29. In another embodiment, the user profile storage 62 may be distributed between the information exchange 29 and external to it. In one embodiment, external and system derived user profile data 63 may be stored in the user profile storage 62.

### The Consumer

In one embodiment, the consumer may enter the selection criteria that defines the type of information item and may also define a type of producer. In another embodiment, the selection criteria may only specify a type of information item or type of producer. In one embodiment, the consumer may enter an action for the selection criteria to specify if the information items matching the criteria are items they would want to receive or not receive. In one embodiment, the action may indicate indifference to receiving it. In one embodiment, the default action may be indifference. In one embodiment, the action assigned to the selection criteria may be assigned by the system from behavior actions of the consumer. For example, by the consumer expressing interest in an a related item or meta data topic.

The consumer can enter more than one selection criteria. In one embodiment, if more than one selection criteria is specified the consumer may specify a priority to define how important the criteria is. Priorities can be expressed by ordering the criteria or by selecting a priority preference input. In one embodiment, the priority of the selection criteria may be assigned by the system from the context of the inputed or derived selection criteria or the behavior, history, or actions leading to the creation of the selection criteria.

In one embodiment, selection criteria and priority for the selection criteria may be determined from performance, historical, behavioral, or tracking data of the consumer. In one embodiment, selection criteria and priority may be determined from predictive statistical methods. In one embodiment, selection criteria entered by the consumer may be combined with selection criteria determined from all other means.

In one embodiment, priorities may be set by the system for each selection criteria. In one embodiment, the system sets a default priority for the selection criteria that can be changed by the consumer.

In one embodiment, the processing of the consumers selection criteria may be integral with the information exchange distributor. In another embodiment, the processing may be external to the default distributor.

In one embodiment, the consumer's selection criteria may be entered by a human. In one embodiment, the selection criteria may be entered by an autonomous agent.

The consumer may enter the selection criteria into a system interface for inputting the selection criteria. The system interface for inputting the selection criteria 68 stores the selection criteria in a selection criteria storage 67. In one embodiment, the selection criteria storage 67 may be part of the information exchange. In another embodiment, the selection criteria storage 67 may be external to the information exchange. In one embodiment, the selection criteria storage 67 may be distributed between the information exchange and external to it. In one embodiment, system derived selection criteria 69 may be stored in the selection criteria storage 67.

In one embodiment, consumers use drag and drop visuals to rank selection criteria and set selection criteria priorities.

In one embodiment, the consumer may be an autonomous agent.

### Information Stream

In one embodiment, for each information item 24 processed a consumer priority may be obtained from the consumer's selection criteria 65 and a producer priority may be obtained from the audience targets 50 for that information item.

In one embodiment, there is no limit on the range of priority levels that can be assigned to audience targets 50 or selection criteria 65. The priority can be of any scale, and the scale can be infinite or fixed or normalized, for example normalized to the zero to one interval.

In one embodiment, the actions for do-not-want and do-not-send multiply their priorities by −1. In one embodiment, if there is no applicable audience target or the action is indifference, the producer priority is represented by 0. In one embodiment, if there is no applicable selection criteria or the action is indifference, the consumer priority is represented by 0.

In one embodiment, for each information item and information consumer there is an information item value pair. The information item value pair includes two metrics. One of the metrics represents the value or priority of the information item to the consumer. The other metric represents the value or priority to the information producer if the information item is consumed by the information consumer. In one embodiment, a possible information item value pair indicates any metric pair within range whether there is an information item having that pair or not. In one embodiment, a region represents a set of possible information item value pairs.

In one embodiment, an include region is used to determine what information items should be included in the information stream of the information consumer. The include region represents a set of producer priority and consumer priority pairs, or equivalently a set of producer item value and consumer item value pairs, or equivalently a set of possible information item value pairs. In one embodiment, the set of pairs is contiguous. In one, embodiment the include region may be specified by a range or ranges for pair values. In one embodiment, the include region may be defined by a threshold line or threshold boundary. In one embodiment, an exclude region specifies the region outside of the include region.

In one embodiment a special process determines if the information item 24 with the producer priority and consumer priority pair, or equivalently the information item value pair, is included in or excluded from the information stream using the include region. In one embodiment, the parameters for the special process are computed from metrics.

### Priority Grid

In one embodiment, a priority grid 70 may represent a range of combinations of producer priority and consumer priority or equivalently a range of information item value pairs. The priority grid 70 may be a continuous or discrete, or a combination of discrete and continuous. The priority grid may also be referred to as a decision matrix or decision grid. The priority grid in some cases will be equivalent to a mathematical set of points contained within a range of values for producer priority and consumer priority. A region of the priority grid would be a sub section of the grid or equivalently a sub set of points.

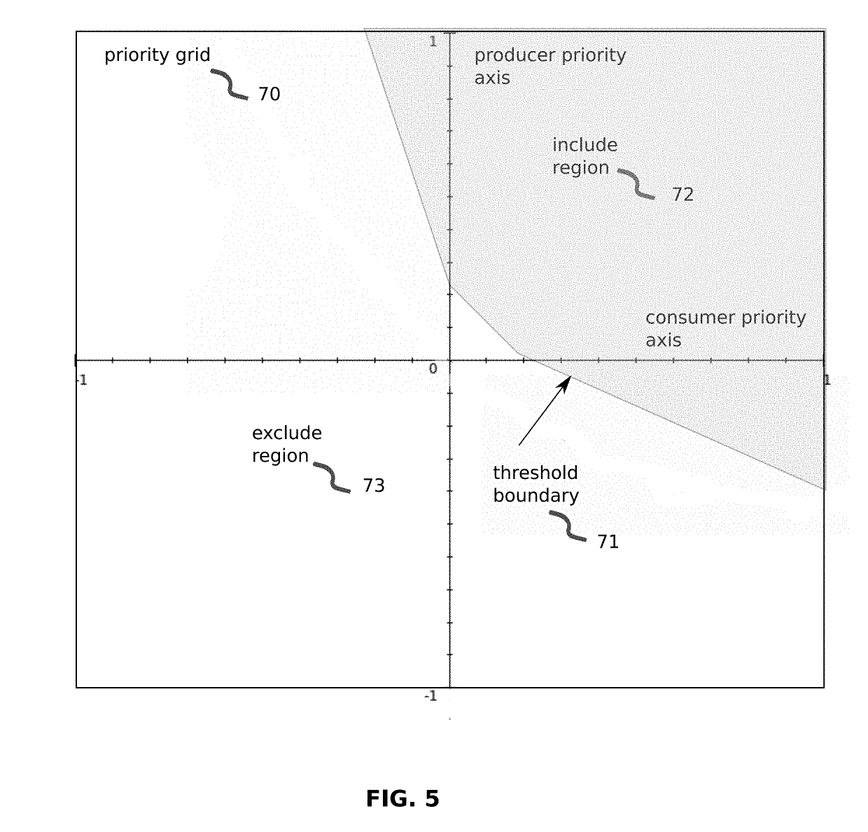

As an example, a sample priority grid is shown in FIG. 5. Mechanically the priority grid may be represented in any number of ways via data structure in the memory or storage of a computer system.

In one embodiment, the priority grid 70 is represented as a two dimensional interval with a range of [1, −1] for each dimension. The two dimensional interval is equivalent to any non-normalized two dimensional interval. The threshold boundary 71 separates the interval into the include region 72 and the exclude region 73. In one embodiment, the priority grid 70 may be used to determine if the information item 24 should be included in the information stream of the consumer 28.

In the discrete case the threshold is a set of cells that form the boundary of the include region 72 and exclude region 73. For example, the threshold set would be the boundary along any row or column in the priority grid 70 where there is a switch from include to exclude. A range or subset of the priority grid 70 is a set of cells or regions in the two dimensional interval.

In one embodiment, the threshold line or boundary can be derived from the metrics 54 and can be represented by a threshold function, map, mapping, or relation. In one embodiment, there may be a priority bounds in the priority grid or decision matrix where the threshold line may not cross.

In one embodiment the exclude region 73 may be divided into a reachable exclude range and a non-reachable exclude range. The reachable exclude range may be defined as the part of the exclude region below the threshold line 71. The reachable exclude range may also be defined as the part of the exclude range that may be reached by the producer, if the producer can increase the priority of the audience target matching that consumer.

In one embodiment, if the information item with information item value pair represented by a point on the priority grid 70d that is within the include region 72 defined by the threshold line 71 for the consumer, the information item is included in the consumer's information stream.

In one embodiment, a discrete priority grid 70 may be constructed from ranges for producer priority and consumer priority by dividing the ranges into discrete points. For example, if the priority ranges are on the [1,−1] interval, dividing the ranges into 10ths would yield 20×20 or 400 discrete points.

### Metrics

The metrics are measures and parameters that may be internal to the information exchange or external to it. Sample internal metrics include, but are not limited to, metrics related to producer, consumer, system information flow, or the information exchange in general. Sample external metrics include, but are not limited to, indications of important sporting events occurring that day, severe weather, day of week, political or business events occurring, measures of news and information flow or activity external to the information exchange, flow activity on external information exchanges, historical projections, statistics, or any other relevant data.

In one embodiment, the processing of the metrics may be integral with the information exchange 29 default distributor 26. In one embodiment, the processing of of the metrics may be external to the default distributor 26. In one embodiment, the processing of the metrics may be distributed between the default distributor and an external system.

In one embodiment, metrics computed, determined, or obtained for the information consumer, and the information consumer may be a specified individual information consumer or a representative information consumer. The representative information consumer may include include representative data and metrics needed to compute or determine additional metrics.

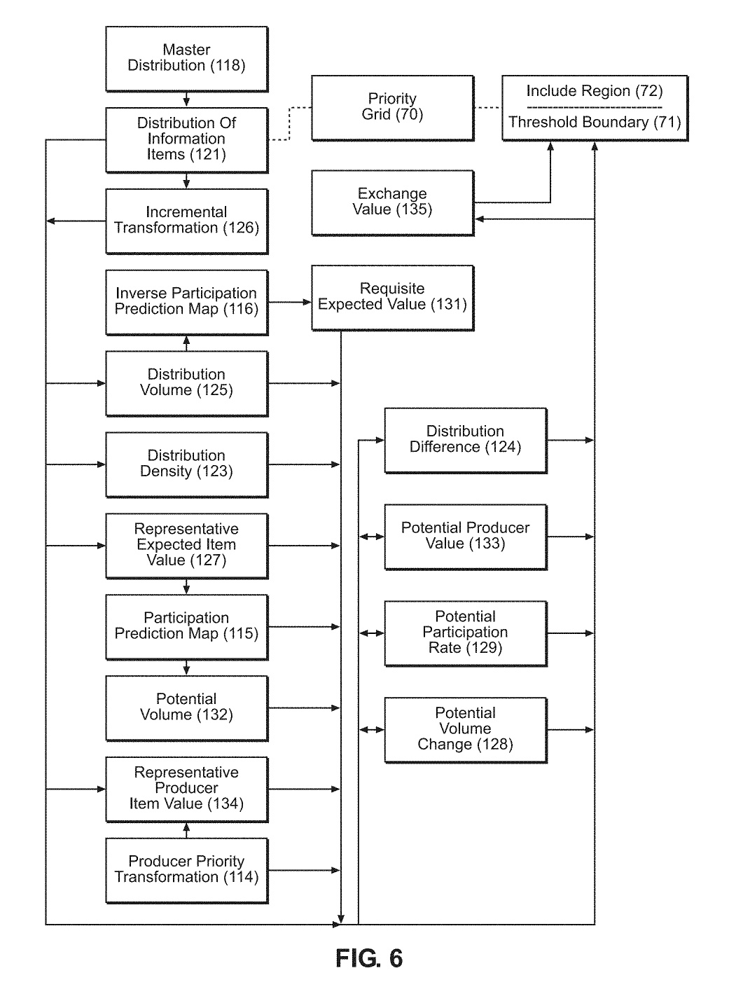

A sample graph with examples of connections and metrics is shown in FIG. 6.

In one embodiment, a consumer participation metric may be used as a measure of information item consumption or interaction with the information item 24. The consumer participation metric may be obtained or computed from views, swipes, interactions, clicks, opens or any other applicable indicator of information item consumption by the consumer and useful to the information exchange. In one embodiment, the participation metric may be exact. In another embodiment, the participation metric may be estimated.

In one embodiment, the participation metric may be a measure of the number of items consumed or participated in for a specified period.

In one embodiment, a participation rate for the information consumer 28 may be measured as the number of information items participated in divided by the number of information items delivered or sent or made available to the consumer over a specified period (for example a day, week, month).

In one embodiment, the participation rate may be obtained from other sources including surveys, monitoring, or other internal and external metrics.

In one embodiment, an historical participation rate may be computed for each consumer. The historical participation rate can be computed in numerous ways from prior participation of the consumer. For example using weighted history, rolling average or other computations. Multiple measures of historical participation can be used.

In one embodiment, a consumer item value for the information item may be estimated for the consumer using the priority established from the selection criteria of the consumer. In one embodiment, the priority of the information item may be the highest priority of matching selection criteria. In another embodiment, the consumer item value may be computed from the priority of overlapping selection criteria. In one embodiment, the consumer item value may be computed from the priority and other metrics.

In one embodiment, a mapping of priority to value for the consumer may be used. In another embodiment, the consumer item value and priority may be assumed to be equivalent.

In one embodiment, an average consumer item value may be computed for a period of time. The average consumer item value may be computed as the sum of the consumer item value for items participated in for the period divided by the number of items participated in for the period. In one embodiment, a weighted average may be used to compute the average consumer item value with weights depending on information item meta data or other metrics. In one embodiment, the average consumer item value may be computed from other statistical techniques. In one embodiment, a historical time series of average consumer item value may be computed.

In one embodiment, a consumer expected item value for an information item the consumer has not yet received is determined or estimated from metrics. In one embodiment, the historical time series of average consumer item value may be used as an estimate of the consumer expected item value. Multiple formula specific to the information exchange can be used for this estimate. For example using weighted history, rolling average or other computations. In one embodiment, the consumer expected item value may be computed from the historical average consumer item value and other metrics. In one embodiment, the consumer expected item value may be computed or obtained from, surveys, sentiment analysis, or other metrics.

In one embodiment, a predictive participation rate may be computed. In one embodiment, the predictive participation rate may be derived from statistical or predictive analytics using the historical participation rate and internal and external metrics and signals. In one embodiment, the predictive participation rate may be the same as the historical participation rate.

In one embodiment, a participation prediction map 115 may be used to relate the consumer expected item value to a predicted participation level. The predicted participation level may represent a number of information items per specified period. The participation prediction map 115 may be a discrete, continuous, or mixed logical function or mapping. In one embodiment, statistical methods appropriate to the information exchange may be used to compute or derive a predictive participation formula or mapping using the consumer expected item value and additional internal or external metrics or signals. In one embodiment, the participation prediction map 115 may be determined using metrics from other consumers.

In one embodiment, an inverse participation prediction map 116 may be used to relate the participation level to an expected item value.

In one embodiment, a producer item value per consumer may be the value to the producer for the consumer to receive and consume an information item. The producer item value may be computed using the priority established from the audience targets for that information item. In one embodiment, the producer item value for a consumer may be computed from the priority and other metrics.

In one embodiment, a mapping of priority to the producer item value per consumer may be used. In another embodiment, the producer item value and priority may be assumed equivalent. In one embodiment a producer priority transformation 114 for mapping or relating producer priory to producer item value is used. Any number of transformations can be used as appropriate for the information exchange and including an identity transformation whereby producer priority and producer item value are equivalent.

In one embodiment, a distribution of information items 121 may be used. In one, embodiment the distribution is over a two dimensional range, interval, region, or space. In one, embodiment the distribution is over one dimension or there may only be one value for all but one of the dimensions. In one embodiment, the dimensions may be consumer priority and producer priority or consumer item value and producer item value. Equivalently the distribution may be over a two dimensional interval or region on the priority grid or a subsection of the priority grid. In one embodiment the distribution indicates the number of information items for a time period for each point in the interval.

In one embodiment the distribution may be represented as a distribution density 123 over the interval or region and a distribution volume or scalar 125. In one embodiment the distribution density 123 may be normalized. In one embodiment the distribution volume 125 may represent the number of items represented by the distribution. The distribution volume 125 is not required to be a whole number.

In one embodiment the distribution of information items 121 may be obtained from an historical accumulation or recording of information items. Numerous techniques specific to the information exchange can be used for recoding the distribution based on historical data. For example using weighted history, rolling average or other computations. The distribution may be computed for each consumer. Multiple distributions are possible and can be used for different purposes in computing other metrics. In one embodiment, aggregations of distributions across information consumers may be used.

In one embodiment, a predicted distribution of information items for a consumer may be computed from one or more historical distributions of information items and optional additional metrics. In one embodiment, the predicted distribution may be computed from metrics alone. In one embodiment, the distribution of information items for a specified future period may be predetermined or assigned.

In one embodiment, a master distribution 118 of information items covering a range, interval or space may be used. In one embodiment, the master distribution may cover the entire priority grid. Each sub region contained in the region covered by the master distribution 118 would have a sub distribution. Reference to the sub region may also refer to the sub distribution over the sub region. The points in the sub distribution referenced by the sub region would be the points from the master distribution 118 that are in the sub region.

In one embodiment, a representative expected item value 127 for the distribution of information items may be computed or assigned. In one embodiment the representative expected item value may depend on the items represented in the distribution. In one embodiment, a distribution value function transforms the distribution to the representative expected item value 127. Numerous different formulas may be used for the distribution value function. For example the value may be computed from the items represented in the distribution as a simple average, weighted average, median, quadratic, or other metric or transformation. As an example, the representative expected item value 127 could be computed as the sum of the consumer item value multiplied by the distribution density value at every point. In one embodiment, other means could be used to compute or assign the representative expected item value 127 for the distribution.

In one embodiment, a potential volume 132 for the distribution is computed as the value obtained from the participation prediction map 115 for the representative expected item value 127 for the distribution. The potential volume 132 may be determined for a single information consumer or from data and metrics for the representative information consumer. The potential volume 132 is not required to be a whole number.

In one embodiment, a requisite expected item value 131 for the distribution is computed as the value obtained from the inverse participation prediction map 116 for the distribution volume 125. The requisite expected item value 131 may be determined for a single information consumer or from data and metrics for the representative information consumer.

In one embodiment, a representative producer item value 134 for a distribution may be computed or assigned. In one embodiment the representative producer item value 134 may depend on the items represented in the distribution. In one embodiment the representative producer item value 134 for a distribution may be computed as the sum of producer item value for each point in the distribution multiplied by the distribution density at that point, or equivalently computed as the sum of the value obtained from the priority transformation of the producer priority for each point of the distribution multiplied by the distribution density at that point.

In one embodiment, a potential producer value 133 from a consumer for a distribution of information items may be computed or assigned. In one embodiment, the potential producer value 133 may depend on the items represented in the distribution. The potential producer value 133 may be computed in numerous different ways from the items represented in the distribution. In one embodiment, the potential producer value 133 for the distribution may be computed as representative producer item value 134 for the distribution multiplied by the potential volume 132 for the distribution.

In one embodiment, multiple distributions can be compared or ranked by evaluating the potential producer value 133 for each distribution. In one embodiment, changes to a distribution may be scored, compared, or ranked by scoring, comparing, or ranking the changes in potential producer value 133 for distributions with and without the change.

In one embodiment, an incremental transformation 126 may transform a specified distribution and a specified set of points to create or generate a new distribution. The density for each of the points may be different or the same. In one embodiment, the transformation may change or set the density for the specified points. The transformation may increase or decrease or hold constant the volume. The transformation may change the region covered by the specified distribution. As an example, the transformation may correspond to adding or removing at least part of an information item with information item value pair for the specified points. In one embodiment, the transformation may preserve the distribution volume. For example, after adding or removing the specified set of points and creating a new normalized density for the new distribution the volume of the new distribution is set to be the original volume of the specified distribution, and thus maintaining the distribution volume and while changing the density.

In one embodiment, a potential volume change 128 between a first and second distributions may be computed. In one embodiment, the potential volume change 128 is determined as the potential volume 132 in the second distribution minus the potential volume 132 in the first. In one embodiment, the potential volume 132 of the second distribution is scaled by the ratio of the volume of the first and second volume. For example, if M and N are the potential volume and volume of the first distribution and M′ and N′ are the same values respectively for the second distribution the projected volume change may be computed as M′−M, or computed as M′ N/N′−M. In one embodiment, the potential volume change 128 is determined from other metrics or other projections.

In one embodiment, a potential participation rate 129 is computed as the ratio of the potential volume 132 and distribution volume 125. In one embodiment, the potential participation rate 129 is determined from other metrics or projections.

In one embodiment, a potential consumer value may be used to indicate the potential value a consumer might obtain from a distribution. In one embodiment, the potential consumer value may be computed as the potential volume 132 multiplied by the representative expected item value 127. In one embodiment, the potential consumer value to a consumer may be determined by other means. For example, potential consumer value could determined by alternative computation, surveys, or other direct measures.

In one embodiment, success metrics may be used to determine a degree of success. Success metrics can depend on a single value or on a vector. Success metric can also relate to comparison of two values or vectors. For example, success metrics may be used when comparing proximity, when iterating, and for temporal comparisons. Numerous different formulas can be used for determining success metrics. In one embodiment, the success metric measures proximity between values or vectors. The measure used could be simple distance, absolute value of distance, ratio, negative penalty, squared difference, cubed difference or other variation. The result of the metric may be logical, numeric, step function, or other suitable variation. For example, the logical or step function may indicate when a value is above or below a threshold or within a range. When used for ranking or comparing the success metric should indicate either an explicit or implicit preference order.

### Exchange Value

In one embodiment, an exchange value 135 indicates a value to the information exchange at a specific point. The specific point may be a point in a space or a tuple or a pair of values or a cell in a matrix or indicated by discrete ranges or an element in a set of points. In one embodiment, the point is a producer priority and consumer priority pair, or a producer item value and consumer item value pair, or a position on the priority grid, or equivalently an information item value pair.

In one embodiment, an exchange value function may be specified or derived to indicate the exchange value 135 at multiple points. The exchange value function may be defined for one or more points or possible information item value pairs. Different exchange value functions could be used for different purposes or depending on the goals of the information exchange. The exchange value function could vary by consumer, temporal parameters, or other internal or external parameters particular to the exchange. There is no limit on the form of the exchange value function or the exchange value. For example the exchange value function could be a discrete mapping, a continuous function, algorithm, or a combination of different forms, and the exchange value 135 could be boolean, numeric, enumeration, text or any computer interpretable form.

In one embodiment, the exchange value function may define boundaries on the priority grid.

In one embodiment the exchange value function may be determined dynamically.

In one embodiment, the exchange value 135 for the specific point is computed from a distribution difference 124 between a specified distribution and a second distribution. In one embodiment, the second distribution is an incremental distribution generated by the incremental transformation 126 of the specified distribution and a set of incremental points that depend on the specific point.

In one embodiment, the distribution difference is the difference in the potential producer value 133 for the specified distribution and the incremental distribution.

In one embodiment, the distribution difference is: (the representative producer item value for the specified distribution)*(the distribution volume for the specified distribution)*(the difference of the potential participation rate between the specified distribution and the incremental distribution)+(the representative producer item value for the incremental points)*(the difference of the distribution volume between the specified distribution and the incremental distribution)*(the potential participation rate for the incremental distribution).

In one embodiment, the distribution difference is: (the representative producer item value for the specified distribution)*(the potential volume change between the specified distribution and the incremental distribution)+(the representative producer item value for the incremental points)*(the difference of the distribution volume between the specified distribution and the incremental distribution)*(the potential participation rate for the incremental distribution).

In one embodiment, the distribution difference is: [(the representative producer item value for the specified distribution)*(the distribution volume for the specified distribution)+(the representative producer item value for the incremental points)*(the difference of the distribution volume between the specified distribution and the incremental distribution)]*(the potential participation rate for the incremental distribution).

In one embodiment, the distribution difference is: F(c|D)+H(p)*G(c|D), where in this formula D is the specified distribution, c is consumer priority or consumer item value at the specific point, and p is the producer priority or producer item value at the specific point. Further, F(c|D) is a function or mapping of c with parameters determined from the specified distribution, D, and with properties that F is monotonically increasing in c over the relevant range around the specific point; H(p) is a function or mapping of p with properties that H<0 if p<0, and H>0 if p>0, and H is monotonically increasing; H may also depend on the volume or density of the point added; and G(c|D) is a function or mapping of c with parameters determined from the specified distribution and with properties over the relevant range around the point such that, if the distribution volume 125 for the incremental distribution is greater than the distribution volume 125 for the specified distribution that G is monotonically increasing and otherwise monotonically decreasing.

As an example, denoting the first distribution as D and the second distribution as D′ with potential volume 132, representative producer item value 134, potential participation rate 129, and number of items respectively as M, U, Q, N for the specified distribution and M′, U′, Q′, N′ for the second distribution, with the potential volume change A, the formula for the exchange value 135 at a point {c, p}, with a single incremental point and producer item value for the point to be v, could be any of the following:

EV(c,p)=UN(M′/N′−M/N)+v(N−N′)M′/N′, or

EV(c,p)=UN(Q′−Q)+v(N−N′)Q′, or

EV(c,p)=[UN+v(N−N′)]M′/N′, or

EV(c,p)=UA+vQ′

at specified c and p pairs.

Any of the computations for exchange value 135 could be combined by any technique useful to create a composite formula. Any of the formulas or composite formulas can be scaled or transformed to create additional variations of the formulas.

In one embodiment the exchange value 135 may be computed for multiple points wherein the specified distribution is the same for each of the points. In one embodiment the specified distribution may be different for different points.

In one embodiment, the exchange value 135 may be used to rank or order points. In one embodiment, the exchange value 135 may be used to rank or order information items. In one embodiment, the exchange value 135 may be used control the order of presentation for information items.

### Include Region and Threshold Boundary

In one embodiment, the include region 70a is determined using a repeated or iterative process of comparing regions until the success metric can not be improved or equivalently the region is equal or preferred to all other regions. Any number of iterative processes can be used to effectively iterate over regions covering the master distribution 118 or relevant range of possible information item value pairs. In one embodiment, the iterative process adjusts a region until the success metric for the adjusted region can not be improved.

In one embodiment, a success metric that determines preference for different proximities of two metrics may be used. In one embodiment, the success metric may be evaluated using comparison metrics for the region. For example, the comparison metrics could be either the potential volume 132 and the distribution volume 125, or the requisite expected item value 131 and the representative expected item value 127. In one embodiment, the include region 70a may be determined when the success metric for the region cannot be improved by switching to another region or when all other regions are of equal preference or less preferred.

In one embodiment, the iterative process adds points in decreasing rank order or removes points in increasing rank order to a current region. In one embodiment, the points to be evaluated or ranked can be limited to points adjacent or nearby to the current region.

In one embodiment, a related point ranking maybe used before the ranking by exchange value 135. In the related point ranking, a point {c, p} is ranked higher than a second point {c′, V} if p>0 and any of these conditions are met, p>p′ and c>c′, p=p′ and c>c′, or p>p′ and c=c′. Limiting the points that need to be ranked or using related point ranking provides for more efficiency and allows for a more refined grid as more grid points can be evaluated per unit of time or fixed number of machine cycles or computing units. The rank order for points not ranked above is determined by computing the exchange value 135 for at least two of those points. In one embodiment, the step of ranking includes related point ranking.

In one embodiment, the exchange value 135 computed for a point is the distribution difference between a specified region and an incremental distribution determined from the specified region and the point or a set of points that depends on or includes the point. In one embodiment, the specified region is the current region.

In one embodiment, the iterative process starts with an initial region 202 or determining an initial region, then completes point computations 204, then evaluates next actions 205. The next actions 205 may include stopping, repeating computations, further computations, or repeat evaluating next actions. In one embodiment, the initial region 202 may be empty or consist of only one point.

In one embodiment, the point computations 204 and further computations comprise steps or actions to: determine a set of points to be used to adjust the current region; rank the points 210; using an incremental transformation to generate a second region 207 by removing from the region or adding to the region one or more of points from the set of points, wherein the points are selected in rank order; compute the success metrics for the current region and the second region.

In one embodiment, the include region 72a may not include a point that has a lower exchange value than a point not in the region or external to the region.

In one embodiment, the set of points used may be limited to the points adjacent to the boundary of the current region. In one embodiment, the set of points used may be all points, or all points not in the current region, or all points in the region. In one embodiment, the set of points may be determined as a subset to the set of points previously added or removed. In one embodiment, the points may be nearby points. In one embodiment, nearby points may be determined as adjacent points to adjacent points or effectively repeating the step of determining adjacent points multiple times. In one embodiment, points may be added or removed depending on if the ratio of the comparison metrics is above or below 1 or other threshold. For example if the potential volume 132 of the region exceeds the distribution volume 125 points are added to expand the region. In one embodiment the number of points added or removed depend on the magnitude of the difference or ratio between the comparison metrics. In one embodiment, the points may be obtained from the priority grid. In one embodiment the set of points is limited to nearby points with a non-zero master distribution density.

In one embodiment, the evaluation of next actions in the iterative process comprise: evaluating if the success metric of the second region 207 is preferred over the current region 206; and if so, repeat the point computations 204 using the second region 207 as the current region; otherwise, if another subset of points from the determined set of points can be added or removed, then generate a new second region using the new subset of points; compute the success metric of the new second region and repeat the evaluation of next actions; if there is no new subset of points that can be added or removed, or if adding or removing any subset of the points does not improve the success metric, the include region 72a is the current region 206.

As an example, where the iterative process adds only one point at a time to expand the region, the steps would be first choosing an initial region. Second, determine a distribution for the current region. Third, rank the adjacent points not in the current region. Fourth, compute a success metric for the current region and determine if the success metric can be improved by expanding the region to include the highest ranked point. Fifth, if the success metric can not be improved, the include region 72a is the current region. Otherwise, expand the current region by adding the highest ranked point and continue with the second step.

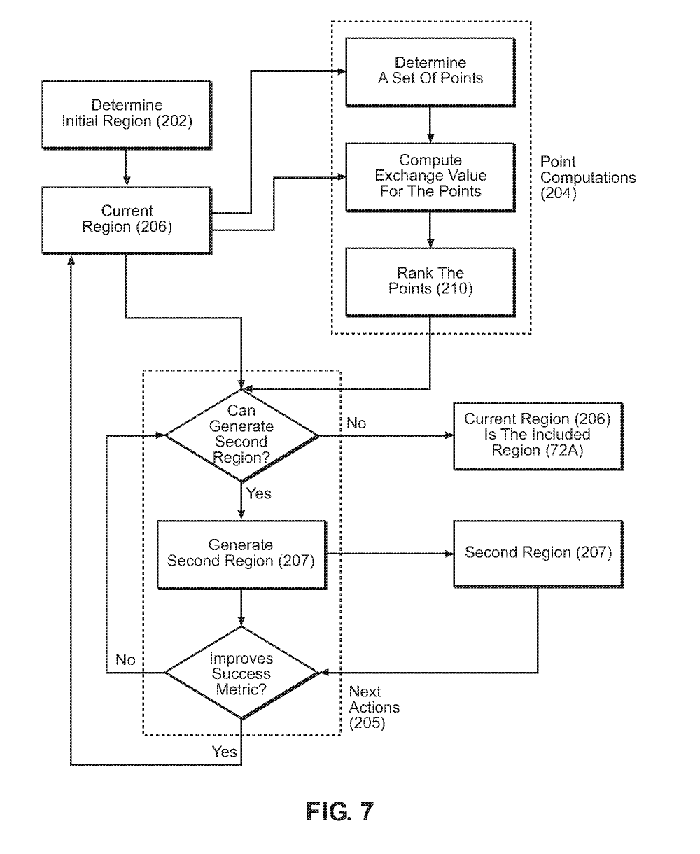

An example of a flow chart for an iterative process or apparatus for determining an include region 72a is shown in FIG. 7.

In one embodiment, multiple information items may be processed at one time as a distribution of information items and the include region 72 can be computed to determine which information items may be included in the consumer's information stream. In one embodiment, information items may be delayed or queued to be evaluated together as a distribution of information items. In one embodiment, the exchange value 135 may be used to rank the order of presentation for the information items. For example, a collection of information items may be available to the information consumer at one time, the collection can be used as the master distribution and an include region can be determined; then the include region can be used to obtain a subset of the large collection; the subset can then be sorted by exchange value and presented to the information consumer.

### Metric Groups and Storage

In one embodiment, historical, real-time, and other data related to consumers, producers, and the information exchange in general may be collected stored in one or more databases or data storage facility or apparatus. For example, the consumer participation metric for specific periods useful to the information exchange, the historical time series of average consumer item value, the historical participation rate for each consumer, and all historical data used for computing or obtaining the consumer participation metrics may be stored in a database or data storage facility or apparatus.

In one embodiment, the distributions of information items that may be relevant for the consumer may be stored in a database. The distributions may be updated in real-time. The threshold boundary 71 or include region may be updated in real time as the distributions or other metrics change.

In one embodiment, a consumer data collection may include the selection criteria, threshold boundary, master distribution 118, distribution over the include region, distribution metrics, other distributions, and other consumer metrics. In one embodiment, the consumer data collection may be stored on contiguous storage for fast access and processing.

### Shift in Metrics and Distribution Shifts and Demand Shifts

In one embodiment, the information exchange may desire to evaluate the implications of a shift in metrics 301. The shift in metrics 301 could be any change in predicted or projected metrics used in determining the include region or in any underlying metrics used to formulate the predicted or projected metrics.

In one embodiment, a shift change value 310 may be used to measure the impact of the shift in metrics 301 for the information consumer. In one embodiment, the shift change value 310 is a measure based on the change in the include region. For example, the change that would result from the shift. In one embodiment, the change is between an initial include region and a post shift include region 305 that would result from the shift.

In one embodiment, the shift change value 310 may be computed from a change in the potential producer value 133, potential consumer value, volume, representative expected item value 127, or other metric. In one embodiment, the change is numeric. In one embodiment, the shift change value 310 may be boolean, step function, or discrete values. For, example the shift change value 310 could be −1, 0, or 1 depending on how the metric moves relative to a threshold. For example −1 if it goes under, 0 if it does not cross the threshold, and 1 if moves over the threshold. This could result in a metric for the net change in the number of consumers above or below said threshold.

In one embodiment, the change in potential producer value 133 may be computed by differing the absolute densities of the distributions over the two include regions, then multiply the resulting density differences by the corresponding producer item value, and sum those values.

In one embodiment, the change in potential consumer value may be computed by differing the absolute densities of the distributions over the two include regions, then multiply the resulting density differences by the corresponding consumer item value, and sum those values.

As an example, denote potential volume 132, volume 125, representative producer item value 134, representative expected item value 127 as M, N, U, S for the include region given the initial master distribution 118 and M′, N′, U′, S′ as those values after the distribution shift. Then possible computations for this example are, the change in potential volume=M−M′, the change in volume=N−N, the change in representative expected item value=S−S′, the change in potential consumer value=M S−M′S′, and the change in potential producer value=U′ M′−U M.

In one embodiment, a shift impact metric 315 may be determined to allow the information exchange to evaluate impact from the shift in metrics 301 or to compare or rank shift alternatives. In one embodiment, the shift impact metric 315 may be computed as the composite, aggregate, sum, segmented sum, weighted sum, median, segmented median, or other combinations of the shift change values for each information consumer or for each representative information consumer. In one embodiment, there may be multiple shift impact metrics computed.

In one embodiment, a set of information consumers potentially impacted 303 by the shift in metrics 301 may be determined before the computations for the shift change value 310.

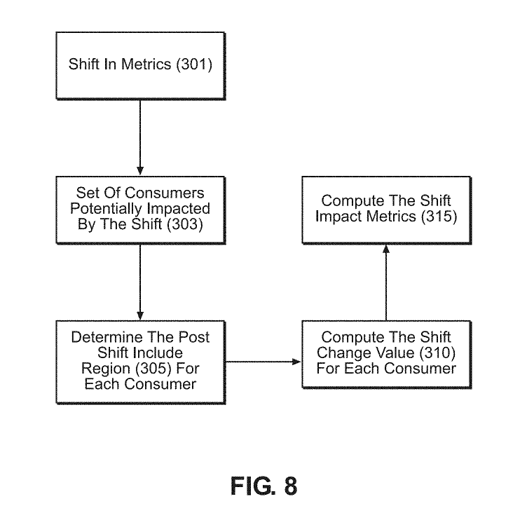

A sample flow chart for evaluation of a shift in metrics 301 is shown in FIG. 8.

In one embodiment, the information exchange may evaluate the implications of a demand shift on the participation prediction map 115 for one or more information consumers. The demand shift may be the result of for example, business mergers or new business competitors with information items similar to the information exchange, changes in delivery technology impacting information consumers, changes in adjacent channels that drive traffic to the information exchange, or other external activities with systemic impact on the information exchange. The demand shift is one example of a shift in metrics 301.

In one embodiment, a second participation prediction map 115 measures the impact of the demand shift on the participation prediction map 115 for each consumer. In one embodiment, if there is no change in the potential volume computed for the representative expected item value 127 using the second participation prediction map 115 relative to the same lookup from the participation prediction map 115 there will be no impact on the information consumer. In one embodiment, a second include region or post shift include region 305 is determined based on the second participation prediction map 115a.

In one embodiment, the information exchange may evaluate the implications of a distribution shift in the information items potentially available to one or more information consumers. The change or potential change may be the result of for example, a modification to the predicted distribution, adding or removing a source of information items, adding or removing contributors, a modification to policy, enacting or lifting a restrictions or regulation, a pricing shift, or any other action or potential action that would result in a potential shift in the master distribution 118 of one or more information consumers. The distribution shift is one example of a shift in metrics 301.

In one embodiment, a second master distribution measures the impact of the distribution shift for each consumer. In one embodiment, if there is no change in the distribution covering the current include region there will be no impact on the information consumer. In one embodiment, a second include region or post shift include region 305 is determined based on the second master distribution.

### CONCLUSION

The systems and methods described here are applicable to existing information exchanges or as basis for new information exchanges to improve effectiveness and efficiency.

Examples and variations given in this specification are not limiting and other examples, combinations, and variations will be apparent to those skilled in the art.

1-13. (canceled)

14. An apparatus for determining an exchange value, comprising of:
a first distribution of information items;
a specific point;
a means for generating a second distribution of information items, wherein the means for generating uses the first distribution and the specific point;
a means for computing a distribution difference between the first distribution and the second distribution, whereby the exchange value for the specific point is the distribution difference.

15. A region generator apparatus, comprising of:
a current region;
a set of points;
a means for computing an exchange value for a point from the set of points, wherein the means for computing uses a distribution difference;
selecting at least one top ranked point from the set of points, wherein the top ranked points are selected by the exchange value;
a means for generating a second region, wherein the means for generating uses the current region and the at least one top ranked point.

16. An apparatus for determining an include region using the apparatus of claim 15, further comprising of:
an initial current region;
computing a success metric for the initial current region
a means for determining a set of points;
using the region generator apparatus of claim 15 with the first region and the set of points determined to generate the second region;
computing a success metric for the second region.
repeating the use of the region generator when the second region is preferred to the current region according to the success metrics, wherein prior to repeating (i) the second region becomes the current region and (ii) a new set of points is determined; and
stopping when a second region cannot be generated that will improve on the current region according to the success metrics, whereby the current region is the include region.

17. The apparatus in claim 16, further comprising:
when the second region is not preferred to current region, repeating the use of the region generator if another set of points can be determined for the current region, wherein prior to repeating a new set of points is determined.

18. The apparatus in claim 14, further comprising:
obtaining at least one exchange value using the apparatus of claim 14;
determining an include region using the at least one exchange value obtained.

19. An apparatus for controlling an information stream using the apparatus from claim 18, further comprising:
an information item;
obtaining an information item value pair for the information item and an information consumer;
obtaining an include region region, wherein the include region obtained was first determined using the apparatus of claim 18;
using the include region and the information item value pair to determine inclusion of the information item into the information stream.

20. A social network using the apparatus of claim 19, comprising:
a post or equivalent information item from a first user of the social network;
a news feed or equivalent information stream of a second user of the social network, wherein second user has friended, followed, subscribed, or equivalently agreed to receive posts from the first user;
a subsystem for determining inclusion of the post into the news feed using the apparatus of claim 19.

21. An advertising system using the apparatus of claim 19, comprising:
one or more information items, whereby the information items comprise any combination of advertisements, offers, solicitations or equivalents;
a subsystem using the apparatus of claim 19 to evaluate inclusion of the information items into the information stream of at least one information consumer.

22. A publishing system using the apparatus of claim 19, comprising:
one or more information items, whereby information items comprise any combination of articles, stories, solicitations, offers, advertisements, messages, notices, videos, audios, or other equivalents received from at least one publisher, author, poster, sender, contributor, or equivalent information producer;
a subsystem using the apparatus of claim 19 to evaluate inclusion of the one or more information items into the information stream of at least one information consumer;
a distributor to deliver the information stream via web, email, mobile, print or other equivalent medium.

23. An information exchange using the apparatus of claim 19, comprising:
a post or equivalent information item obtained from a first user of the information exchange;
a distributor;
a second user of the information exchange allowed to receive the post via the distributor;
a subsystem using the apparatus of claim 19 to determine exclusion of the post from the information stream of the second user.

24. An apparatus for selecting information items for presentation to an information consumer using the apparatus of claim 14, further comprising of:
a collection of information items;
using the collection as a master distribution;
obtaining at least one exchange value using the apparatus of claim 14;
determining an include region using the at least one exchange value obtained and the master distribution;
use the include region to determine a subset of the collection to present to the information consumer.

25. The apparatus of claim 24, wherein the subset is sorted using an exchange value.

26. A method for determining an exchange value, comprising:
a specific point;
a specified distribution of information items;
compute a distribution difference for the point by the formula F(c|D)+H(p)*G(c|D) with consumer dimension c and producer dimension p and parameters determined from the specified distribution D, and wherein over the relevant range around the point
(i) F is monotonically increasing in c,
(ii) H(p)*p>0 and H(0)=0,
(iii) H is monotonically increasing in p,
(iv) G is monotonically increasing when the point is added and monotonically decreasing when the point is removed;
whereby the exchange value for the point is the distribution difference.

27. A method for selecting at least one top ranked points from a set of points using the method of claim 26, further comprising of:
a set of points;
for each of the points compute the exchange value using the method of claim 26, wherein a point from the set of points and the first distribution are used;
compare the exchange values of the points to select the top ranked points.

28. The method of claim 27, further comprising of:
an initial set of points;
a step for limiting the initial set of points to compare, wherein the result is the set of points.

29. A method for determining an include region using the method of claim 26, further comprising:
a possible information item value pair;
obtaining an exchange value for the information item value pair using the method of claim 26;
a step for determining an include region, wherein the step for determining uses the exchange value.

30. A method for operating an information exchange using the method of claim 29, further comprising:
an information item;
obtain an information item value pair for the information item and an information consumer;
obtain an include region region, wherein the include region obtained was determined using the method of claim 29;
use the include region and the information item value pair to determine inclusion of the information item into the information stream of the information consumer.

31. The method of claim 30, further comprising:
obtain an audience target from the information item;
obtain at least one selection criteria;
obtain the information item value pair using the audience target and at least one selection criteria.

32. A method for determining an exchange value for multiple points, comprising of:
(a) a set of points;
(b) a first distribution;
(c) compare the points by exchange value to determine at least one top ranked points,
wherein the exchange value is computed for at least the top ranked points by computing a distribution difference between the first distribution and an incremental transformation of the first distribution using the point;
(d) transform the first distribution using the top ranked points to a new distribution;
(e) remove the top ranked points from the set of points; and
(f) repeat (c) through (f) with the remaining points using the new distribution as the first distribution until there are no points remaining; whereby the exchange value is computed for the set of points.

33. A method for generating a potential include region, comprising of:
a first region;
a set of points;
a master distribution;
determine a first distribution for the first region, wherein the first distribution is the part of the master distribution in the first region;
compare the points by exchange value to determine at least one top ranked point, wherein the exchange value is computed for at least one point by computing a distribution difference between the first distribution and an incremental transformation of the first distribution using the point;
generate a second region by adjusting the first region at the at least one top ranked point.

34. A method for generating an include region using the method of claim 33, comprising of:
(a) an initial first region;
(b) a step for determining a set of points, wherein the step for determining uses the first region;
(c) generate a second region using the method of claim 33 with the first region and the set of points;
(d) compute success metrics for the first region and the second region;
(e) when the success metrics indicate the second region improves the first region, designate the second region as the new first region and repeat steps (b) through (e); and
(f) stop when the success metric for the first region can not be improved, whereby the first region is the include region.
